(19) United States
(12) Patent Application Publication
(10) Pub. No.: US 2014/0152057 A1
(43) Pub. Date: Jun. 5, 2014

(54) HEATED HEADREST

(71) Applicants: Scott E. Truant, Windsor (CA); Stefano Ranalli, Auburn Hills, MI (US)

(72) Inventors: Scott E. Truant, Windsor (CA); Stefano Ranalli, Auburn Hills, MI (US)

(21) Appl. No.: 13/690,060

(22) Filed: Nov. 30, 2012

(51) Int. Cl. B60N 2/48

(52) U.S. Cl. CPC B60N 2/4876
USPC 297/180.12

(57) ABSTRACT

A vehicle seat is provided that may include a seat cushion, a seatback, a headrest and a heating element. The seatback may extend upward from the seat cushion. The headrest may extend from the seatback. The heating element embedded in one of the seat cushion, the seatback and the headrest. The heating element may be electrically coupled with an electrical power source and a pressure-sensitive switch. The pressure-sensitive switch may selectively allow and prevent electrical communication between the heating element and the electrical power source.

### FIELD

The present disclosure relates to a heated headrest for a vehicle seat.

### BACKGROUND

Modern vehicles are provided with heating, ventilation and air conditioning systems to heat and cool an occupant cabin of the vehicle. While modern heating systems are generally proficient at heating the occupant cabin, it may be desirable to provide a vehicle seat with one or more heaters to quickly warm surfaces of the seat to quickly warm the occupant and improve the occupant's comfort.

### SUMMARY

The present disclosure provides a headrest for a seat. The headrest may include a resiliently compressible member, a heating element, a pressure-sensitive switch, and an upholstery layer. The heating element may be in electrical communication with a power source. The pressure-sensitive switch may be electrical connected with the heating element and the power source. The upholstery layer may encase the compressible member, the heating element and the pressure-sensitive switch.

In some embodiments, the headrest may include a thermostat electrically connected to the heating element and deactivating the heating element in response to sensing a predetermined temperature.

In some embodiments, the upholstery layer may include one or more of leather, suede, cloth and vinyl.

In some embodiments, the headrest may include a mounting post adapted to adjustably engage a seatback of the seat. Wires electrically connected to the heating element may extend through the mounting post. The wires may include first ends coupled with the heating element and second ends coupled to an electrical connector. The electrical connector may be adapted to engage a corresponding connector attached to the seatback.

In some embodiments, the heating element may be disposed between the resiliently compressible member and the upholstery layer.

In some embodiments, the resiliently compressible member may include a foam material.

In some embodiments, the heating element may be electrically coupled to a manual-override switch that is configured to control the heating element independently of the pressure-sensitive switch.

In another form, the present disclosure provides a vehicle seat that may include a seat cushion, a seatback, a headrest and a heating element. The seatback may extend upward from the seat cushion. The headrest may extend from the seatback. The heating element embedded in one or more of the seat cushion, the seatback and the headrest. The heating element may be electrically coupled with an electrical power source and a pressure-sensitive switch. The pressure-sensitive switch may selectively allow and prevent electrical communication between the heating element and the electrical power source.

In some embodiments, the heating element and the pressure-sensitive switch may be disposed in the headrest.

In some embodiments, the headrest may include a resiliently compressible member and an upholstery layer encasing the compressible member, the heating element and the pressure-sensitive switch.

In some embodiments, the heating element may be disposed between the resiliently compressible member and the upholstery layer.

In some embodiments, the upholstery layer may include leather, suede, cloth and/or vinyl.

In some embodiments, the resiliently compressible member may include a foam material.

In some embodiments, the electrical power source is disposed remotely from the seat cushion, the seatback and the headrest.

In some embodiments, the headrest includes a thermostat electrically connected to the heating element to deactivate the heating element in response to sensing a predetermined temperature.

In some embodiments, the headrest may include a mounting post adapted to adjustably engage the seatback. Wires electrically connected to the heating element may extend through the mounting post. The wires may include first ends coupled with the heating element and second ends coupled to an electrical connector. The electrical connector may be adapted to engage a corresponding connector attached to the seatback.

In some embodiments, the heating element may be electrically coupled to a manual-override switch that is configured to control the heating element independently of the pressure-sensitive switch.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle seat having a headrest according to the principles of the present disclosure;

FIG. 2 is a partial front view of the vehicle seat of FIG. 1;

FIG. 3 is a partial cross-sectional view of the headrest according to the principles of the present disclosure; and

FIG. 4 is a schematic diagram of a headrest heating system according to the principles of the present disclosure.

### DETAILED DESCRIPTION

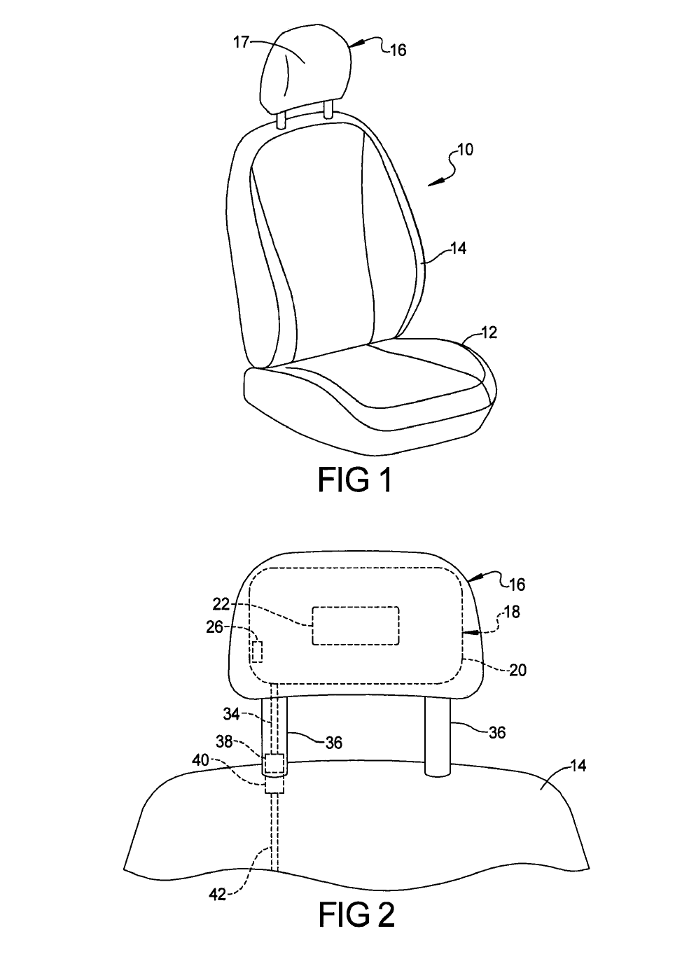

In an exemplary embodiment and with reference to FIGS. 1-4, a seat 10 is provided that may include a seat cushion 12, a seatback 14, a headrest 16 and a heating system 18. The seat 10 can be configured for installation in a vehicle (not shown) such as an automobile, an airplane, a train, or a boat, for example, or any other type of vehicle. As will be subsequently described, the heating system 18 may be operable to heat one or more of the seat cushion 12, seatback 14 and/or headrest 16.

The heating system 18 may include a heating element 20, a first switch 22, a battery 24 (or any other source of electrical power) and a second switch 26. The heating element 20 may include a plurality of resistive elements, such as wires, for example, that generate heat in response to receiving electrical current. It will be appreciated that any type of heating element could be used that generates heat in response to receiving electrical current. In some embodiments, the heating element 20 could be a relatively thin, flexible sheet. In some embodiments, the heating system 18 may include a plurality of heating elements 20 that maybe embedded in the seat cushion 12, the seatback 14 and/or the headrest 16. The first and second switches 22, 26 may be electrically connected to the one or more heating elements 20 and the battery 24 and may be operable to control a flow of electrical current between the battery 24 and the one or more heating elements 20.

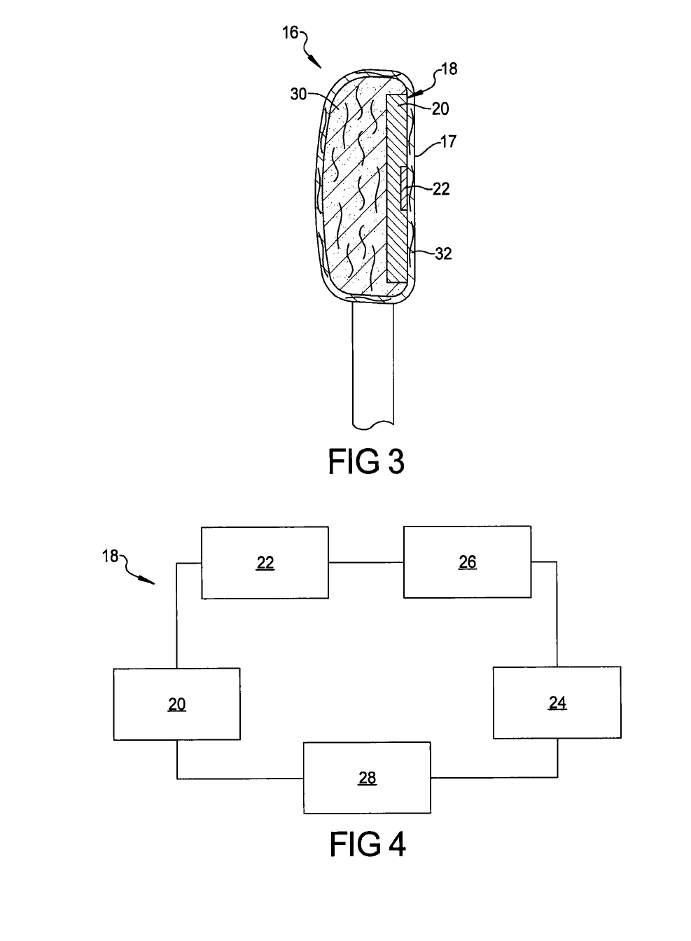

In the particular embodiment shown in FIGS. 2 and 3, the heating element 20 may be disposed in a forward-facing portion 17 of the headrest 16. As shown in FIG. 3, the heating element 20 may be disposed between a foam cushioning layer 30 of the headrest 16 and an upholstery layer 32 (e.g., a layer of leather, suede, cloth or vinyl upholstery) of the headrest 16. The heating element 20 may conform to the shape and contours of the forward-facing portion 17 of the headrest 16. In some embodiments, the foam cushioning layer 30 could completely surround the heating element 20.

The first switch 22 may be a pressure-sensitive switch electrically connected to the heating element 20 and the battery 24. The first switch 22 can be embedded in the headrest 16 proximate the heating element 20. The first switch 22 may include a pressure sensor that is positioned and configured to detect when a user (e.g., a passenger or driver) rests his or her head against the headrest 16. In response to detecting a force associated with a user resting or pressing his or her head against the headrest 16, the first switch 22 may close to complete the electrical circuit connecting the heating element 20 and the battery 24 so that electrical current from the battery 24 may reach the heating element 20, thereby causing the heating element 20 to generate heat. Heat from the heating element 20 may be conducted through the upholstery layer 32 and/or the foam cushioning layer 30 to the user's head. When the first switch 22 no longer detects the force associated with the user's head resting on the headrest 16, the first switch 22 may open to prevent electrical current from reaching the heating element 20.

In some embodiments, the first switch 22 may open to prevent electrical current from reaching the heating element 20 immediately after the pressure sensor senses that the user's head is no longer resting against the headrest 16. In other embodiments, however, the heating element 20 may continue to operate for a predetermined amount of time after the user removes his or her head from the headrest 16.

The second switch 26 may include a thermostat disposed in the headrest 16 proximate the heating element 20. The second switch 26 may sense a temperature of the heating element 20 and/or a temperature of material proximate the heating element 20. The second switch 26 may close to allow electrical current to flow from the battery 24 to the heating element 20 if the sensed temperature is less than a predetermined value. If the sensed temperature is greater than a predetermined value, the second switch 26 may open to prevent electrical current from reaching the heating element 20. It will be appreciated that in some embodiments, electrical current may be able to reach the heating element 20 only when both of the first and second switches 22, 26 are closed (i.e., the first switch 22 senses the requisite level of force and the second switch 26 senses a temperature less than the predetermined value).

In some embodiments, the heating system 18 may include a manual-override switch 28 disposed in the electrical circuit between the heating element 20 and the battery 24. The manual-override switch 28 could be disposed on the seat cushion 12, the seatback 14 or an instrument panel or center console of the vehicle, for example, or any other location that is accessible to the user while the user is sitting in the seat 10. The manual-override switch 28 may be operable to prevent electrical current from reaching the heating element 20 even if the first switch 22 detects the user's head resting on the headrest 16 and the second switch 26 senses a temperature that is lower than the predetermined value. In some embodiments, the manual-override switch 28 may be operable to allow electrical current to reach the heating element 20 even when the first switch 22 does not detect the user's head resting on the headrest 16.

The battery 24 could be disposed remotely from the seat 10, such as in an engine compartment of the vehicle in which the seat 10 is installed or any other suitable location. In some embodiments, the battery 24 could be disposed in any suitable location in or on the seat 10. Wires 34 connecting the heating element 20 with the battery 24 may extend from the headrest 16, through one of a pair of mounting posts 36, and into the seatback 14. The mounting posts 36 connect the headrest 16 to the seatback 14 and provide for adjustment of a position of the headrest 16 relative to the seatback 14. The wires 34 may be coupled to a first electrical connector 38 that engages a second electrical connector 40 in the seatback 14 when the mounting posts 36 are attached to the seatback 14. Wires 42 extending from the second electrical connector 40 may extend through the seatback 14 and seat cushion 12 and may be electrically connected to the battery 24.

While the heating element 20 and the first and second switches 22, 26 are described above and shown in the figures as being disposed in the headrest 16, it will be appreciated that in some embodiments, the heating element 20 and/or switches 22, 26 could be disposed in the seat cushion 12 and/or seatback 14.

What is claimed is:

1. A headrest for a seat comprising:
a resiliently compressible member;
a heating element in electrical communication with a power source;
a pressure-sensitive switch electrically connected with the heating element and the power source; and
an upholstery layer encasing the compressible member, the heating element and the pressure-sensitive switch.

2. The headrest of claim 1, further comprising a thermostat electrically connected to the heating element and deactivating the heating element in response to sensing a predetermined temperature.

3. The headrest of claim 1, wherein the upholstery layer includes one or more of leather, suede, cloth and vinyl.

4. The headrest of claim 1, further comprising a mounting post adapted to adjustably engage a seatback of the seat, and wherein wires electrically connected to the heating element extend through the mounting post.

5. The headrest of claim 4, wherein the wires include first ends coupled with the heating element and second ends coupled to an electrical connector, and wherein the electrical connector is adapted to engage a corresponding connector attached to the seatback.

6. The headrest of claim 1, wherein the heating element is disposed between the resiliently compressible member and the upholstery layer.

7. The headrest of claim 1, wherein the resiliently compressible member includes a foam material.

8. The headrest of claim 1, wherein the heating element is electrically coupled to a manual-override switch that is configured to control the heating element independently of the pressure-sensitive switch.

9. A vehicle seat comprising:
a seat cushion;
a seatback extending upward from the seat cushion;
a headrest extending from the seatback; and
a heating element embedded in one of the seat cushion, the seatback and the headrest, the heating element being electrically coupled with an electrical power source and a pressure-sensitive switch selectively allowing and preventing electrical communication between the heating element and the electrical power source.

10. The vehicle seat of claim 9, wherein the heating element and the pressure-sensitive switch are disposed in the headrest.

11. The vehicle seat of claim 10, wherein the headrest includes a resiliently compressible member and an upholstery layer encasing the compressible member, the heating element and the pressure-sensitive switch.

12. The vehicle seat of claim 11, wherein the heating element is disposed between the resiliently compressible member and the upholstery layer.

13. The vehicle seat of claim 11, wherein the upholstery layer includes one or more of leather, suede, cloth and vinyl.

14. The vehicle seat of claim 11, wherein the resiliently compressible member includes a foam material.

15. The vehicle seat of claim 9, wherein the electrical power source is disposed remotely from the seat cushion, the seatback and the headrest.

16. The vehicle seat of claim 9, wherein the headrest includes a thermostat electrically connected to the heating element to deactivate the heating element in response to sensing a predetermined temperature.

17. The vehicle seat of claim 9, wherein the headrest includes a mounting post adapted to adjustably engage the seatback, and wherein wires electrically connected to the heating element extend through the mounting post.

18. The vehicle seat of claim 17, wherein the wires include first ends coupled with the heating element and second ends coupled to an electrical connector.

19. The vehicle seat of claim 18, wherein the electrical connector is adapted to engage a corresponding connector attached to the seatback.

20. The vehicle seat of claim 9, wherein the heating element is electrically coupled to a manual-override switch that is configured to control the heating element independently of the pressure-sensitive switch.
